(19) United States
(12) Patent Application Publication
(10) Pub. No.: US 2014/0127380 A1
(43) Pub. Date: May 8, 2014

(54) METHOD OF PREPARING KIMCHI SOURCE

(71) Applicant: SE GYOUNG SHIN, Gwangcheon-eup (KR)

(72) Inventor: SE GYOUNG SHIN, Gwangcheon-eup (KR)

(21) Appl. No.: 13/774,450

(22) Filed: Feb. 22, 2013

(30) Foreign Application Priority Data
Nov. 6, 2012 (KR) 10-2012-0124554
Nov. 6, 2012 (KR) 10-2012-0124555
Nov. 6, 2012 (KR) 10-2012-0124556
Nov. 6, 2012 (KR) 10-2012-0124557

(51) Int. Cl. A23L 1/221

(52) U.S. Cl. CPC A23L 1/221
USPC 426/589; 426/638

(57) ABSTRACT

A method of preparing a kimchi sauce that includes common kimchi ingredients as main ingredients and may be added in various dishes is provided. The method includes: a pre-treatment process of cutting a Chinese cabbage and grinding garlic; a first process of adding starch syrup, white sugar, L-sodium glutamate, citric acid, refined salt, capsicum, perillar oil, roasted sesame seed, grapefruit extract, and at least two of ingredients and heating the mixture to obtain a first process product; a second process of adding modified starch, xanthan gum, and oleoresin paprika to the first process product, uniformly mixing to obtain a mixture, and heating the mixture for gelatinization to thicken the mixture as a second process product; cooling the second process product; adding a fermented vinegar and an alcohol to the cooled product and uniformly mixing to obtain a mixture; filling a packing container with the mixture using a filler; and refrigerating.

### CROSS-REFERENCE TO RELATED PATENT APPLICATION

This application claims the benefit of Korean Patent Application No. 10-2012-0124554, filed on Nov. 6, 2012, Korean Patent Application No. 10-2012-0124555, filed on Nov. 6, 2012, Korean Patent Application No. 10-2012-0124556, filed on Nov. 6, 2012, and Korean Patent Application No. 10-2012-0124557, filed on Nov. 6, 2012, in the Korean Intellectual Property Office, the disclosures of which are incorporated herein in their entirety by reference.

### BACKGROUND OF THE INVENTION

1. Field of the Invention

The present invention relates to a method of preparing a kimchi source, and more particularly, to a method of preparing a kimchi source including common kimchi ingredients as main ingredients for use in various dishes.

2. Description of the Related Art

Patent Publication No. 10-2010-0106786 (Oct. 4, 2012) discloses seasoning ingredients for kimchi, and Patent Publication No. 10-1992-0005917 (Apr. 27, 1992) discloses a kimchi source used in preparing kimchi-topped cooked rice.

### SUMMARY OF THE INVENTION

One or more embodiments include a method of preparing a kimchi source using common kimchi ingredients as main ingredients, and additional seasoning ingredients, including meats, seafood, and/or vegetables. The kimchi source may be used in a variety of foods or dishes to add taste.

According to an aspect of the present invention, there is provided a method of preparing a kimchi source, the method including:

a pre-treatment process of cutting a Chinese cabbage and grinding garlic;

a first process of adding starch syrup, white sugar, L-sodium glutamate, citric acid, refined salt, capsicum, perillar oil, roasted sesame seed, grapefruit extract, and one or a mixture of at least two of ingredients in powder form or extract form selected from among meats including pork, beef, and chicken, processed meat products including ham, bacon, and sausage, seafoods including shellfish, oyster, squid, octopus, abalone, sea cucumber, lobster, crab, king crab, albacore, tuna, and Pollack, processed seafood products, vegetables including tomatoes, potatoes, onion, green pepper, and cabbage, processed vegetable products, and mushrooms including Pleurotus eryngii, Agaricus bisporus, shiitake mushroom, and oyster mushroom, and processed mushroom products, and heating the mixture to obtain a first process product;

a second process of adding modified starch, xanthan gum, and oleoresin paprika to the first process product, uniformly mixing to obtain a mixture, and heating the mixture for about 10 minutes to 30 minutes for gelatinization to thicken the mixture as a second process product;

cooling the second process product to a temperature of about 40□ to about 75□;

adding a fermented vinegar and an alcohol to the cooled product and uniformly mixing to obtain a mixture;

filling a packing container with the mixture using a filler; and

refrigerating the packing container containing the mixture.

In the pre-treatment process of cutting of the Chinese cabbage and grinding the garlic, the Chinese cabbage may be cut to a size of about 10 to 15 cm by about 10 to 15 cm, or may be ground to a size of about 10 to 80 mesh.

The first process of heating may include steam-heating in a steam cooker for about 30 to 60 minutes.

### BRIEF DESCRIPTION OF THE DRAWING

The above and other features and advantages of the present invention will become more apparent by describing in detail exemplary embodiments thereof with reference to the attached drawing in which:

FIG. 1 is a flowchart of a method of preparing a kimchi source, according to an embodiment of the present invention.

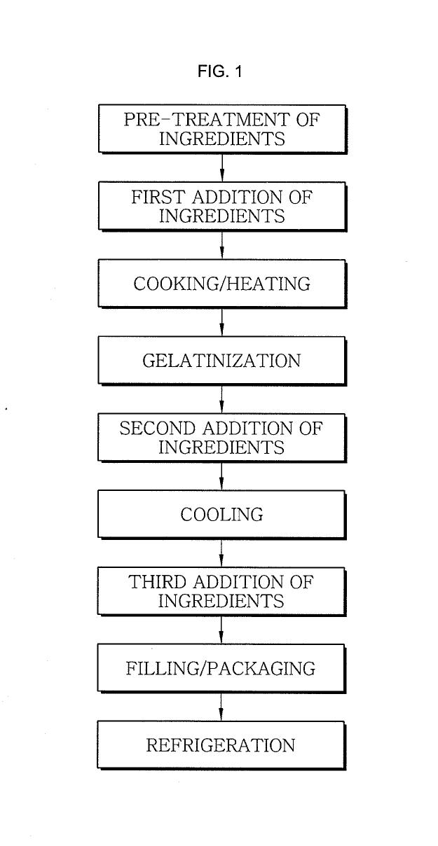

### DETAILED DESCRIPTION OF THE INVENTION

As used herein, the term “and/or” includes any and all combinations of one or more of the associated listed items. Expressions such as “at least one of,” when preceding a list of elements, modify the entire list of elements and do not modify the individual elements of the list.

According to one or more embodiments of the present invention, a kimchi source may be prepared in two types depending on the initial processing methods of kimchi ingredients.

One of the two types is a kimchi source with crispy texture. For this type of the kimchi source, a Chinese cabbage may be cut to a size of about 10˜15 cm by about 10˜15 cm. The other type is a kimchi source with non-crispy, soft texture. In this regard, a Chinese cabbage may be ground to a size equivalent to a mesh size of about 10 to about 80. Along with the cabbage as a kimchi ingredient, garlic is minced or ground.

The pre-treatment process is followed by a first process of adding other ingredients and heating. Ingredients added to the prepared Chinese cabbage and garlic in the first process may include starch syrup, white sugar, L-sodium glutamate, citric acid, refined salt, capsicum (for example, Oleoresin Capsicum), perillar oil, roasted sesame seed, grapefruit extract. In the first process, one or a mixture of at least two of meats or seafoods may be further added and mixed together with the other ingredients. Examples of the meats are pork, beef, chicken, meat-taste seasoning power, and a meat extract. In some embodiments, instead of the meat-taste seasoning power or meat extract, processed meat products, including ham, bacon, sausage, and other livestock and dairy products, may be used. When using a ham or bacon, the ham or bacon may be cut, for example in a rectangular shape of a size of about 5 mm by about 10 mm.

The meats or seafoods may be replaced with vegetables or mushrooms. Non-limiting examples of the seafoods are shellfish, oyster, squid, octopus, abalone, sea cucumber, lobster, crab, king crab, albacore, tuna, and Pollack. Non-limiting examples of the vegetables are tomatoes, potatoes, onion, green pepper, and cabbage. Non-limiting examples of the mushrooms are Pleurotus eryngii, Agaricus bisporus, shiitake mushrooms, and oyster mushrooms. These ingredients may be used in powder form, extract form, any of a variety of processed forms, or original raw form. When used as raw materials or processed forms, the ingredients may be cut in a rectangular shape of a size of about 5 mm by about 10 mm. The meats, seafood, or vegetables may be not used. In this regard, although the kimchi flavor may not mingle with the original taste of the meats, seafood, or vegetables, the kimchi source may have simple, strong kimchi flavor.

In the heating of the ingredients, the ingredients may be steam-heated for about 30 to about 60 minutes at a boiling point. The steam-heating is for preventing burning of the ingredients. When the heating time is greater than this range, the flavors of the ingredients may not mingle well. Rather, the tastes of the ingredients may change badly. In the first process, the heating of the ingredients may be not necessary. Only the mixing of the ingredients may be enough.

The first process may be followed by a second process of gelatinization with other ingredients. After the first process of heating, modified starch, xanthan gum, seasoned pepper powder, or oleoresin paprika may be added to the first process product, mixed uniformly, and heated for about 10 to 30 minutes for gelatinization. If the ingredients added in the second process are added together with the ingredients added in the second process, they may not have original tastes or function properly. For example, when the modified starch and the pepper powder are added together with the ingredients used in the first process, a soft, body taste of the starch may not be obtained.

The second process of gelatinization may be followed by a third process of cooling the product from the second process to a temperature of about 40□ to about 75□, adding fermented vinegar and alcohol, and uniformly mixing the product. When the vinegar and alcohol are added without cooling, tastes and characteristics of the vinegar and alcohol may be changed. After completion of the third process and cooling, the kimchi source may be packed using a filler. The packing may be performed using any of a variety of materials, including a plastic (PET) container, an iron can, a retort pouch, or glass bottles. The final product may be keep refrigerated.

The amounts of the ingredients used in the above-described processes for preparing the kimchi source may be as follows.

About 0.5-3 parts by weight of the garlic, 5-15 parts by weight of the starch syrup (high fructose), 0.1-2 parts by weight of the L-sodium glutamate, about 0.1-0.5 parts by weight of the citric acid, 0.5-2 parts by weight of the oleoresin paprika, about 0.5-3 parts by weight of the refined salt, 0.1-5 parts by weight of the modified starch, 0.01-0.1 parts by weight of the xanthan gum, and about 0.5-5 parts by weight of the one or the mixture of at least two of the ingredients in powder or extract form selected from among the meats, including pork and beef, and seafoods including shellfish, oyster, squid, octopus, abalone, sea cucumber, lobster, crab, king crab, albacore, tuna, and pollack, each based on 100 parts by weight of the Chinese cabbage, may be used.

The meats or seafoods may be used as raw materials or processed products (for example, as ham, bacon, sausage, other livestock or daily products, or the like), not as powder (seasoned) or extract form. When the meats or seafoods are used as raw materials or processed products, an amount thereof may be about from 3 parts to about 10 parts by weight, which is more than the amount used as powder or extract form. When a ham or bacon is used, it may be cut in a rectangular shape of a sixe of about 5 mm by about 10 mm. As alternatives to the meats, vegetables tomatoes, potatoes, onion, green pepper, and cabbage, and mushrooms including Pleurotus eryngii, Agaricus bisporus, shiitake mushroom, and oyster mushroom, which may be in powder or extract form, may be used. These vegetables or mushrooms may be used as raw materials or processed products, not only as powder or extract form.

Further to the above-listed ingredients, about 0.5 parts to about 5 parts by weight of the fermented vinegar, about 0.005 parts to about 0.03 parts by weight of the capsicum, about 0.1 parts to about 1 part by weight of the perillar oil, about 0.1-1 parts by weight of the roasted sesame seed, about 0.1 parts to about 1.5 parts by weight of the alcohol, and about 0.01 parts to about 0.1 parts by weight of the grapefruit extract, each based on 100 parts by weight of the Chinese cabbage, may be additionally used.

When the amount of the garlic is above the range of 0.5-3 parts by weight, the original flavor of the garlic may be too strong to mingle with the other ingredients. When the amount of the garlic is less than the range of 0.5-3 parts by weight, the original kimchi flavor originating from hot, spicy garlic taste may be too weak. When the amounts of the starch syrup and white sugar exceed the above ranges, sweet taste may be too strong. L-sodium glutamate is widely known as a tasty seasoning agent. Although D-sodium glutamate has no special taste, L-sodium glutamate provides a good taste. When the amount of the D-sodium glutamate is within the above range, its flavor may mingle well with the other ingredients. The citric acid having sour taste may serve as a seasoning agent. When the amount of the citric agent is within the above, its flavor may mingle well with the other ingredients. When the amount of the citric acid exceeds the above range, the sour taste may be too strong. The refined salt provides a salty taste, which is one of the significant tastes affecting an overall taste of foods. When the amount of the refined salt exceeds the above range, the salty taste may be too strong. When the amount of the refined salt is less than the above range, the kimchi source may not tasty.

The modified starch is a food additive used for improving adhesion, viscosity, emulsifying stability, and physical characteristics and texture of foods. The modified starch is mostly used as a thickening agent for goods. When the amount of the modified starch is within the above range, physical properties and emulsifying stability of the kimchi source may be improved. It is unnecessary to use a larger amount of the modified starch than the above range.

Xanthan gum is a natural thickening agent, which is a mixture of glucose, mannose, and sodium glucuronate, potassium glucuronate, or calcium glucuronate with a large-molecular weight polysaccharide (carbohydrate polymer) powder that is produced by cultivation and fermentation of carbohydrate with the bacterium Xanthomonas Campestris, which is known as a cause of cabbage's bacterial pustule, purifying the fermented product with isopropyl alcohol, and drying and grinding the purified product. Xanthan gum is soluble in water and insoluble in ethanol. Xanthan gum is dispersible in cold water and dissoluble in hot water. The viscosity of xanthan gum when dissolved in hot water is nearly constant irrespective of the temperature of the hot water. Xanthan gum has a high viscosity, as compared to other thickening agents. The higher the concentration of xanthan gum, the higher the viscosity becomes. Reportedly, xanthan gum may be used as a weight loss agent for overweight people. Xanthan gum may be used as a stabilizer, a thickening agent, a binder, an emulsifying agent, a firming agent, or a foam agent for food, and may also be used in low-calorie foods. The xanthan gum used in the embodiments of the present invention serves as a stabilizer and emulsifier. When the amount of the xanthan gun is within the above range, it may properly function as a stabilizer and emulsifier. It is unnecessary to use a larger amount of the xanthan gum than the above range. This may deteriorate the tastes of the other ingredients in the kimchi source.

The meats including beef, pork, chicken, and the like, the seafood, the vegetables, and the mushrooms may be used as powder form or extract form, which allows easy handling of the ingredients. In some other embodiments, the meats, seafood, vegetables, and mushrooms may be used as raw materials, or as a mixed form of raw materials, powder form and/or extract form.

When animal ingredients are added to kimchi ingredients, they may enhance sweet, savory flavors. When the amount of the meats exceeds the above range, animal flavors may be too strong. The amount of the meats within the above range is appropriate to provide sweet, savory taste. The use of the seafoods with the kimchi ingredients may enhance a refreshing taste. When the amount of the seafoods exceeds the above range, the kimchi source may have strong fishy smells. The amount of the seafoods within the above range is appropriate to provide a refreshing taste. The use of the mushrooms or vegetables together with the kimchi ingredients may eliminate an odd taste of the mushrooms and enhance simple, fresh tastes from the raw vegetables, resulting in enriched tastes mingled well with the tastes of the kimchi ingredients. When the amount of the vegetables or the mushrooms exceeds the above range, excess water may be generated from the vegetables, or inherent tastes of the vegetables or mushrooms may be too strong. Since vegetables or mushrooms have a large volume relative to weight, the above ranges of amounts of the vegetables and mushrooms may be sufficient.

Fermented vinegar contains about 60 kinds or more various organic acids, including acetic acid, citric acid, malic acid, and tartaric acid, generated through fermentation, essential amino acids, vitamins, minerals, and other unidentified bioactive substances. Although the organic acids in the vinegar are acidic, they contribute to alkalifying the body fluid by being involved in the body metabolism of the human body. The human body has a neutral pH in normal conditions, but is liable to be acidified from exposure to severe stress or fatigue, or from intake of harmful foods. Such an acidified human body is vulnerable to infections, tumor growth, or cancers. Thus, the alkalifying effect of vinegar is very advantageous to the human body. Furthermore, when added to foods, vinegar may sterilize harmful viruses or residual agricultural chemicals or toxins in vegetables or fruits. Vinegar may facilitate intestinal mobility in the human intestine and absorption of nutrients into the body. When the amount of the fermented vinegar exceeds the above range, sour taste may be too strong, and thus deteriorate the overall taste of the kimchi source.

Capsicum is used to give a hot taste. An example of the capsicum is Oleoresin Capsicum. Capsicum may be added at an initial stage of the process together with the Chinese cabbage. When capsicum is added later than the beginning of the process, the taste of the capsicum may be too strong. In embodiments of the present invention, in addition to the other seasoning ingredients of the kimchi source, the perillar oil and roasted sesame seeds may be used to give a nutty-like flavor to the kimchi source. When small amounts of the perillar oil and roasted sesame seeds are used within the above ranges, they may have a nutty-like flavor. When the amounts of the perillar oil and roasted sesame seeds exceed the above ranges, the perillar oil and roasted sesame seeds may not be mingled well with the tastes of the other ingredients, and may taste too oily. In embodiments of the present invention, the alcohol added in the kimchi source may be a fermented alcohol, which may suppress growth of microorganisms for food preservation purposes. Grapefruit extract is an anti-biotic substance obtained by extracting grapefruits seeds with water and ethyl alcohol or glycin, and is a natural preserving agent, listed in the Korea Food Additive Codex, used for preventing food acidification and enhancing food preservability. A commercially available grapefruit extract may be used.

In the first process, when the Chinese cabbage is added with garlic, starch syrup, white sugar, L-sodium glutamate, citric acid, refined salt, one or a mixture of at least two of the meats, seafoods, mushrooms, vegetables, and processed products thereof in powder form or extract form, capsicum, perillar oil, roasted sesame seeds, and grapefruit extract, and heated together, the tastes of all these ingredients may be mingled well without any strong individual tastes of the ingredients.

In the second process of gelatinization of additional other ingredients, the additional ingredients may be heated separate from the ingredients added in the first process, to appropriately function according the purposes of using the additional ingredients, not deteriorating the overall taste of the kimchi source. For example, the modified starch may be added separate from the ingredients added in the first process, i.e., after the first process, to provide inherent thickening characteristics and soft, body taste of the starch to the kimchi source.

Hereinafter, the present invention will be described in detail with reference to the following examples of mixing ingredients in different ratios. However, these examples are for illustrative purposes only and are not intended to limit the scope of the present invention.

### EXAMPLE 1

About 1.72 parts by weight of garlic, about 11.6 parts by weight of starch syrup (high fructose), about 8.32 parts by weight of white sugar, about 0.50 parts by weight of L-sodium glutamate, about 0.24 parts by weight of citric acid, about 1.06 parts by weight of oleoresin paprika powder, about 1.32 parts by weight of refined salt, about 2.11 parts by weight of modified starch, about 0.05 parts by weight of xanthan gum, about 1.72 parts by weight of one of beef, pork, and chicken in powder form or extract form, about 1.72 parts by weight of fermented vinegar, about 0.01 parts by weight of capsicum, about 0.4 parts by weight of perillar oil, about 0.52 parts by weight of roasted sesame seeds, about 0.79 parts by weight of alcohol, and about 0.04 parts by weight of grapefruit extract, each based on 100 parts by weight of Chinese cabbage, were mixed together.

In another example of the kimchi source, about 1.72 parts by weight of the one of the beef, pork, and chicken was replaced with about 1.72 parts by weight of one or a mixture of at least two of the ingredients in powder form or extract form selected from among the seafoods including shellfish, oyster, squid, octopus, abalone, sea cucumber, lobster, crab, king crab, pollack, albacore, tuna, and tuna; vegetables including tomatoes, potatoes, onion, green pepper, and cabbage; and vegetables including Pleurotus eryngii, Agaricus bisporus, shiitake mushroom, and oyster mushroom.

### EXAMPLE 2

In Example 2, the ingredients were weighed in kg.

About 75.66 kg of Chinese cabbage was mixed with garlic about 1.3 kg of garlic, about 8.8 kg of starch syrup (high fructose), 6.3 kg of about of white sugar, about 0.38 kg of L-sodium glutamate, about 0.18 kg of citric acid, about 0.8 kg of oleoresin paprika powder (referred to also as seasoned pepper powder), about 1.00 kg of refined salt, about 1.60 kg of modified starch, about 0.04 kg of xanthan gum, about 1.30 kg of one of beef, pork, and chicken in powder form or extract form, fermented vinegar about 1.30 kg of fermented vinegar, about 0.01 kg of capsicum, about 0.3 kg of perillar oil, about 0.4 kg of roasted sesame seed, about 0.6 kg of alcohol, and about 0.03 kg grapefruit extract.

In other examples of the kimchi source, about 1.30 kg of the one of the beef, pork, and chicken were replaced with about 1.30 kg of seafoods including fishes, vegetables, and mushrooms in powder form or extract form, or an amount of one of the beef, pork, and chicken was used in a combination with seafoods including fishes, vegetables, and mushrooms in powder form or extract form.

### EXAMPLE 3

About 1.72 parts by weight of garlic, about 11.6 parts by weight of starch syrup, about 8.32 parts by weight of white sugar, about 0.50 parts by weight of L-sodium glutamate, about 0.24 parts by weight of citric acid, about 1.06 parts by weight of oleoresin paprika powder, about 1.32 parts by weight of refined salt, about 2.11 parts by weight of modified starch, about 0.05 parts by weight of xanthan gum, about 6 parts by weight of one or a mixture of at least two of minced beef, pork, chicken, and processed meat products, including ham and bacon, 1.72 parts by weight of fermented vinegar, 0.01 parts by weight of capsicum, about 0.4 parts by weight of perillar oil, about 0.52 parts by weight of roasted sesame seed, about 0.79 parts by weight of alcohol, about 0.04 of grapefruit extract, each based on 100 parts by weight or Chinese cabbage, were used.

When using meat, such as beef, as a raw material, or a processed meat product such as ham, these ingredients were cut for use, not be used in powder or extract form. In addition, an amount of the meat or the processed meat product was larger than the amounts of these ingredients in powder form or extract form. Instead of the meats or processed meat products, one or a mixture of at least two of minced seafoods, vegetables, mushrooms, and processed products thereof were used.

### EXAMPLE 4

Ingredients for a kimchi source were mixed in the same manner as in Example 3, except that the one or mixture of at least two of minced beef, pork, chicken, the processed meat products, including ham and bacon, the seafoods, including fishes, and the vegetables were not added to obtain more strong kimchi-like flavor.

As described above, according to the one or more embodiments of the present inventions, a kimchi source may be prepared as a convenient packed product with a high commercial value. The kimchi source may be readily used in cooking a variety of dishes, including stir-fried rices, salads, fish dishes, meat dishes, barbecue sources, confectionery sources, and dressings to add taste with a high commercial value.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of preparing a kimchi sauce, the method comprising:
a pre-treatment process of cutting a Chinese cabbage and grinding garlic;
a first process of adding starch syrup, white sugar, L-sodium glutamate, citric acid, refined salt, capsicum, perillar oil, roasted sesame seed, grapefruit extract, and one or a mixture of at least two of ingredients in powder form or extract form selected from among meats including pork, beef, and chicken, processed meat products including ham, bacon, and sausage, seafoods including shellfish, oyster, squid, octopus, abalone, sea cucumber, lobster, crab, king crab, albacore, tuna, and Pollack, processed seafood products, vegetables including tomatoes, potatoes, onion, green pepper, and cabbage, processed vegetable products, and mushrooms including Pleurotus eryngii, Agaricus bisporus, shiitake mushroom, and oyster mushroom, and processed mushroom products, and heating the mixture to obtain a first process product;
a second process of adding modified starch, xanthan gum, and oleoresin paprika to the first process product, uniformly mixing to obtain a mixture, and heating the mixture for about 10 minutes to 30 minutes for gelatinization to thicken the mixture as a second process product;
cooling the second process product to a temperature of about 40 degrees Celsius to about 75 degrees Celsius;
adding a fermented vinegar and an alcohol to the cooled product and uniformly mixing to obtain a mixture;
filling a packing container with the mixture using a filler; and
refrigerating the packing container containing the mixture.

2. The method of claim 1, wherein, in the pre-treatment process of cutting of the Chinese cabbage and grinding the garlic, the Chinese cabbage is cut to a size of about 10 to 15 cm by about 10 to 15 cm, or is ground to a size of about 10 to 80 mesh.

3. The method of claim 1, wherein the first process of heating comprises steam-heating in a steam cooker for about 30 to 60 minutes.

4. The method of claim 1, wherein about 0.5-3 parts by weight of the garlic, about 5-20 parts by weight of the starch syrup, about 5-15 parts by weight of the white sugar, about 0.1-2 parts by weight of the L-sodium glutamate, about 0.1-0.5 parts by weight of citric acid, about 0.5-2 parts by weight of the oleoresin paprika, about 0.5-3 parts by weight of the refined salt, about 0.1-5 parts by weight of the modified starch, about 0.01-0.1 parts by weight of the xanthan gum, about 0.5-5 parts by weight of the one or at least two of the meats, seafoods, vegetables, and mushrooms in powder or extract, about 0.5-5 parts by weight of the fermented vinegar, about 0.005-0.03 parts by weight of the capsicum, about 0.1-1 parts by weight of the perillar oil, about 0.1-1 parts by weight of the roasted sesame seed, 0.1-1.5 parts by weight of the alcohol, and about 0.01-0.1 parts by weight of the grapefruit extract, each based on 100 parts by weight of the Chinese cabbage, are used.

5. The method of claim 1, wherein about 0.5-3 parts by weight of the garlic, about 5-20 parts by weight of the starch syrup, about 5-15 parts by weight of the white sugar, about 0.1-2 parts by weight of the L-sodium glutamate, about 0.1-0.5 parts by weight of the citric acid, about 0.5-2 parts by weight of the oleoresin paprika, about 0.5-3 parts by weight of the refined salt, about 0.1-5 parts by weight of the modified starch, about 0.01-0.1 parts by weight of the xanthan gum, about 3-10 parts by weight of one or a mixture of at least two of the meats, seafoods, processed meat products, and processed seafood products, about 0.5-5 parts by weight of the fermented vinegar, about 0.005-0.03 parts by weight of the capsicum, about 0.1-1 parts by weight of the perillar oil, about 0.1-1 parts by weight of the roasted sesame seed, about 0.1-1.5 parts by weight of the alcohol, about 0.01-0.1 parts by weight of the grapefruit extract, each based on 100 parts by weight of Chinese cabbage, are used.

6. The method of claim 1, wherein about 0.5-3 parts by weight of the garlic, about 5-20 parts by weight of the starch syrup, about 5-15 parts by weight of the white sugar, about 0.1-2 parts by weight of the L-sodium glutamate, about 0.1-0.5 parts by weight of the citric acid, about 0.5-2 parts by weight of the oleoresin paprika, about 0.5-3 parts by weight of the refined salt, about 0.1-5 parts by weight of the modified starch, about 0.01-0.1 parts by weight of the xanthan gum, about 1-5 parts by weight of one or a mixture of at least two of the vegetables, the processed vegetable products, the mushrooms, and the processed mushroom products, about 0.5-5 parts by weight of the fermented vinegar, about 0.005-0.03 parts by weight of the capsicum, about 0.1-1 parts by weight of the perillar oil, about 0.1-1 parts by weight of the roasted sesame seed, about 0.1-1.5 parts by weight of the alcohol, 0.01-0.1 parts by weight of the grapefruit extract, each based on 100 parts by weight of the Chinese cabbage, are used.

7. A method of preparing a kimchi sauce, the method comprising:
a pre-treatment process of cutting a Chinese cabbage and grinding garlic;
adding starch syrup, white sugar, L-sodium glutamate, citric acid, refined salt, capsicum, perillar oil, roasted sesame seed, grapefruit extract, one or a mixture of at least two ingredients in powder or extract form, the ingredients being selected from among meats, processed meat products, seafood, processed seafood products, vegetables, processed vegetable products, mushrooms, and processed mushroom products, to the Chinese cabbage and the garlic to obtain a mixture, and heating the mixture;
adding modified starch, xanthan gum, and oleoresin paprika to the mixture and uniformly mixing and heating the mixture for about 10 to about 30 minutes for gelatinization to thicken the mixture;
cooling the resulting mixture to about 40 degrees Celsius to about 75 degrees Celsius;
adding fermented vinegar and alcohol to the resulting product and uniformly mixing to obtain a mixture;
filling a packing container with the mixture using a filler; and
refrigerating the packing container containing the mixture.
